(19) United States
(12) Patent Application Publication
(10) Pub. No.: US 2025/0383299 A1
(43) Pub. Date: Dec. 18, 2025

(54) PHYSICS AUGMENTED REGRESSION ALGORITHM FOR CRITICAL DIMENSIONS IN LARGE PITCH TARGETS

(71) Applicant: KLA Corporation, Milpitas, CA (US)

(72) Inventors: Phillip R. ATKINS, San Jose, CA (US); Jinchuan SHI, Milpitas, CA (US)

(21) Appl. No.: 19/212,621

(22) Filed: May 19, 2025

Related U.S. Application Data
(60) Provisional application No. 63/660,570, filed on Jun. 17, 2024.

(51) Int. Cl. G01N 21/95

(52) U.S. Cl. CPC G01N 21/9501; G01N 2201/126

(57) ABSTRACT

Methods and systems for determining information for a specimen are provided. One system includes a metrology subsystem that detects signals responsive to illumination of a target structure on a specimen. The system also includes a physics augmented regression algorithm and an objective function. The objective function is configured for separation of relationships between the detected signals and different physical characteristics of the target structure. The physics augmented regression algorithm determines one or more of the different physical characteristics of the target structure from the detected signals.

### BACKGROUND OF THE INVENTION

### 1. Field of the Invention

The present invention generally relates to methods and systems for determining information for a specimen. Certain embodiments include a physics augmented regression algorithm that includes an objective function configured for separation of relationships between detected signals and different physical characteristics of a target structure on the specimen.

### 2. Description of the Related Art

The following description and examples are not admitted to be prior art by virtue of their inclusion in this section.

Fabricating semiconductor devices such as logic and memory devices typically includes processing a specimen such as a semiconductor wafer using a number of semiconductor fabrication processes to form various features and multiple levels of the semiconductor devices. For example, lithography is a semiconductor fabrication process that typically involves transferring a pattern to a resist arranged on a semiconductor wafer. Additional examples of semiconductor fabrication processes include, but are not limited to, chemical-mechanical polishing, etch, deposition, and ion implantation. Multiple semiconductor devices may be fabricated in an arrangement on a semiconductor wafer and then separated into individual semiconductor devices.

Metrology is performed at various steps during a semiconductor manufacturing process to monitor and control the process. Unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology is also different than defect review in that, unlike defect review in which defects that are detected by inspection are re-visited in defect review, metrology may be performed at locations at which no defect has been detected. In other words, unlike defect review, the locations at which metrology is performed on a specimen may be independent of the results of an inspection performed on the specimen. In particular, the locations at which metrology is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which metrology is performed may be determined before inspection has been performed on the specimen.

Many different types of metrology processes are currently used in semiconductor manufacturing. Many such metrology processes cannot determine the patterned feature characteristics directly from the images. In other words, the metrology processes may have to simulate what the metrology results might look like for various values of characteristics of a structure being measured and compare the simulation results to the measured results. Once a match between the simulated and measured results has been found, the characteristics of the structure may be determined as the ones that generated the matching simulated results. The simulations may take various forms and may be used with several different kinds of regression algorithms.

In one such example, to measure the critical dimension (CD) parameters of a target, some currently used metrology processes apply optimization algorithms like a gradient-based nonlinear regression algorithm, such as the N2X algorithm or non-gradient methods like surrogate optimization. One crucial step for these regression algorithms is calculating the simulated signal, then using the difference between the measurement target signal and the simulated target signal to compute the Residual and Jacobian matrix (in the case of gradient searches). The algorithm uses this information to update the CD parameters of the target. The regression algorithm is an iterative algorithm; it repeats the simulation, the Jacobian calculation (if needed), and updates the input CD parameters multiple times until it converges to an acceptable error threshold.

Obtaining a target's accurate simulated signal is one of the most critical steps in the CD parameter extraction process. The performance of this step will directly affect the final accuracy of the regression algorithm and the running speed of the algorithm. Currently, an electromagnetic engine based on the rigorous coupled-wave analysis (RCWA) algorithm is used to calculate the simulated signal for the target.

Within the architecture of regression algorithms, the formulation of the objective function stands as a pivotal element given its decisive role in determining the Residual and the Jacobian, thereby dictating the trajectory of the search direction. Currently, the signal chi-square-based objective function is usually used in the regression algorithm.

There are a number of important disadvantages to the currently used metrology methods and systems. For example, the chi-square-based regression algorithm works well for non-linear curve fitting. However, when applied to large pitch, deep trench targets and deep through-silicon via (TSV) targets, currently used chi-square-based regression algorithms for the extraction of depth and bottom CD (BCD) parameters encounter distinct challenges.

In one such example, signals for such targets are characterized by an abundance of high-frequency, small-amplitude oscillations, which, within the context of a chi-square objective function, precipitate an extensive proliferation of local minima. This proliferation of local minima significantly complicates the optimization trajectory, because the algorithm can become ensnared within these local minima thereby engendering substantial inaccuracies in depth and BCD fitting results.

In another such example, the local minima cause outliers in the processing of precision spectra, which in turn significantly compromises both static and dynamic precision. This phenomenon must be avoided given that precision ranks paramount in current requirements for spectral analysis. Addressing this challenge is essential for advancing spectral analysis methodologies and ensuring they meet substantially high standards of precision.

The accuracy of depth fitting outcomes plays a critical role in determining the fitting precision of the BCD parameter for this particular class of target. It has been observed that the regression algorithm yields satisfactory BCD fitting results predominantly when the depth fitting accuracy is maintained at a relatively high level. This interdependency indicates that discrepancies in depth fitting, particularly those stemming from outliers, have a propensity to propagate errors to the BCD parameter estimation. This phenomenon underscores the essential need for precise depth parameter estimation as a foundational step towards achieving reliable and accurate BCD parameter fitting in regression analysis.

One approach to mitigating the impact of depth outliers in chi-square-based regression algorithms involves the utilization of global scan seeding techniques. This method necessitates initiating the regression process from a multitude of starting depth values, a strategy aimed at circumventing the detrimental effects of outliers on the regression outcome. However, this technique significantly decelerates the regression algorithm due to the repetitive nature of the process initiated from these various starting points. Furthermore, the efficacy of global scan seeding is contingent upon the density of the seeding points; insufficiently dense seeding may not guarantee the complete elimination of outliers. Therefore, while global scan seeding presents a potential solution to the outlier problem, its practical application is hindered by limitations in efficiency and the inability to consistently achieve outlier-free results, highlighting a critical area for improvement in regression algorithm methodologies.

All of the above challenges have resulted in outliers and failure cases with measuring relatively large pitch targets. The currently used method does allow us to determine depth, but not with the robustness needed to meet precision requirements. The currently used method also does not determine the BCD, which is a key determination in many semiconductor fabrication processes.

Accordingly, it would be advantageous to develop systems and methods for determining information for a specimen that do not have one or more of the disadvantages described above.

### SUMMARY OF THE INVENTION

The following description of various embodiments is not to be construed in any way as limiting the subject matter of the appended claims.

One embodiment relates to a system configured for determining information for a specimen. The system includes a metrology subsystem configured for illuminating a target structure on a specimen with an energy source and detecting signals responsive thereto. The system also includes a computer subsystem and a physics augmented regression algorithm executed by the computer subsystem and including a regression algorithm and an objective function. The objective function is configured for separation of relationships between the detected signals and different physical characteristics of the target structure. The computer subsystem is configured for inputting the detected signals into the physics augmented regression algorithm. The physics augmented regression algorithm is configured for determining one or more of the different physical characteristics of the target structure from the inputted detected signals. The system may be further configured as described herein.

Another embodiment relates to a computer-implemented method for determining information for a specimen. The method includes illuminating a target structure on a specimen with an energy source and detecting signals responsive thereto. The illuminating and detecting are performed with a metrology subsystem. The method also includes determining one or more of different physical characteristics of the target structure by inputting the detected signals into a physics augmented regression algorithm.

The physics augmented regression algorithm includes a regression algorithm and an objective function. The objective function is configured for separation of relationships between the detected signals and the different physical characteristics of the target structure. The inputting is performed by a computer subsystem.

Each of the steps of the method may be performed as described further herein. The method may include any other step(s) of any other method(s) described herein. The method may be performed by any of the systems described herein.

An additional embodiment relates to a non-transitory computer-readable medium storing program instructions executable on a computer system for performing a computer-implemented method for determining information for a specimen. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 2 are schematic diagrams illustrating side views of embodiments of a system configured as described herein;

FIG. 3 is a schematic diagram illustrating a side view of one example of a target structure for which the embodiments described herein are particularly suited;

FIG. 4 is a schematic diagram illustrating a cross-sectional, perspective view of another example of a target structure for which the embodiments described herein are particularly suited;

FIG. 5 is a plot showing an example of a comparison of spectroscopic reflectometry (SR) simulations for a target spectra vs. an initial spectra guess for different depths of a target structure described herein;

FIG. 6 is a plot showing an example of a comparison of k-space intensity of the spectra shown in FIG. 5 for different depths;

FIG. 7 is a plot showing an example of a comparison of the phase slopes of the spectra shown in FIG. 5 for different depths;

FIG. 8 is a plot showing an example of a chi-square cost function determined for the spectra shown in FIG. 5 as a function of depth;

FIG. 9 is a plot showing an example of a phase counting cost function determined for the spectra shown in FIG. 5 as a function of depth;

FIG. 10 is a plot showing an example of a k-space intensity cost function determined for the spectra shown in FIG. 5 as a function of depth;

FIG. 11 is a plot showing an example of a k-space unwrapped phase slope cost function determined for the spectra shown in FIG. 5 as a function of depth;

FIG. 12 is a flow diagram showing one embodiment of a multi-pass regression that may be performed by the physics augmented regression algorithm embodiments described herein;

FIG. 13 is a schematic diagram illustrating a perspective view of one example of a large pitch, deep through-silicon via (TSV) structure;

FIG. 14 is a plot of an example of large pitch, deep TSV depth parameter fitting linearity determined for the TSV structure shown in FIG. 13 using k-space intensity;

FIG. 15 is a plot of one example of large pitch, deep TSV depth parameter fitting linearity determined for the TSV structure shown in FIG. 13 using k-space unwrapped phase slope;

FIG. 16 is plot of one example of a wafer map of depth for a process of record (POR) wafer;

FIG. 17 is plot of one example of a wafer map of depth for a POR+ wafer;

FIG. 18 is a plot of an example of the linearity using the k-space intensity and chi-square cost functions for the TSV structure shown in FIG. 13;

FIG. 19 is a schematic diagram illustrating a perspective view of one example of a large pitch, deep TSV structure that is deeper than that shown in FIG. 13;

FIG. 20 is a plot of one example of linearity of the depth fitting results generated for the TSV structure shown in FIG. 19;

FIG. 21 is a plot of one example of depth fitting results showing the DOE wafer splits generated for the TSV structure shown in FIG. 19;

FIG. 22 is a plot of one example of the dynamic precision for the depth parameter generated for the TSV structure shown in FIG. 19; and

FIG. 23 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

The embodiments described herein include systems and methods configured for determining information for a specimen. More specifically, the embodiments described herein include a physics augmented regression algorithm that can be used for determining critical dimensions (CDs) of relatively large pitch targets. The physics augmented regression algorithm embodiments described herein, designed for relatively large pitch targets, marks a significant advancement in extracting the critical depth parameter of target structures such as deep trench targets and through-silicon via (TSV) targets, which has been a persistent challenge. For example, gradient-based regression algorithms that may be used to determine such CDs often encounter local minima when extracting the depth, leading to outlier results.

The presence of depth outliers has a profound and detrimental impact on the precision metric. “Depth outliers” as that term is used herein is generally defined as regressed depth values that are relatively far away from their true values due to local minima issues during regression that are common for structures described herein. These anomalies can be hard to detect unless precision testing is being done. For example, for precision testing, regression on repeated measurements of the same wafer location may be performed. The spectra between different measurements will have relatively small differences in the measurement signal. Therefore, the regressed values should be substantially similar. However, any results of regressions that get trapped in a local minima will look like outliers compared to others not trapped in a local minima. These anomalies can also cause a significant, adverse influence on the fitting outcomes of other CDs, like the bottom CD (BCD). In other words, when a depth that is too far away from its true value is input to BCD fitting, it can greatly downgrade the fitting accuracy for the BCD parameter. This intricate interplay between the depth outliers and BCD parameter accuracy underscores the critical importance of the new algorithm embodiments described herein.

The embodiments described herein provide a new regression algorithm that isolates the depth parameter from other model parameters that dominate the currently used gradient-based algorithms. In doing so, the embodiments can advantageously achieve a faster, more accurate, and higher precision determination of the depth. “Determining” as that term is used herein, e.g., with respect to physical characteristics of a target structure, is most broadly defined as generating an output responsive to the physical characteristics. In particular, the determinations performed as described herein are not direct determinations, but are generated by determining the differences between simulated signals and detected signals for a target structure and then iteratively generating the simulated signals with different parameters until the simulated and detected signals are similar enough, i.e., match within some predetermined criteria.

Therefore, the determined physical characteristics generated by the embodiments described herein may also be commonly referred to in the relevant art as “estimated” or “predicted” physical characteristics, rather than say “measured” characteristics.

In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, personal computer (PC) boards, and other semiconductor specimens.

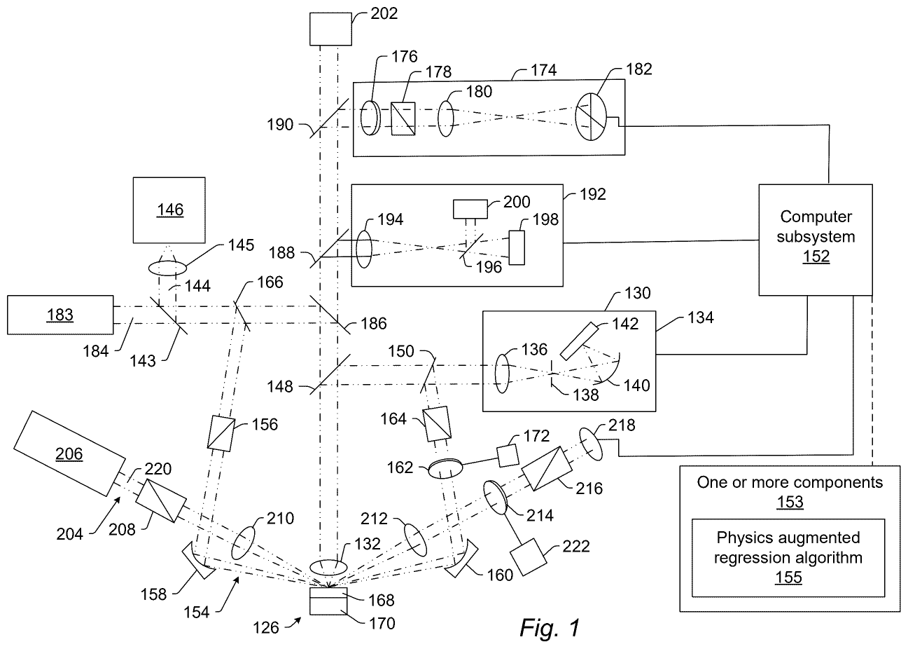

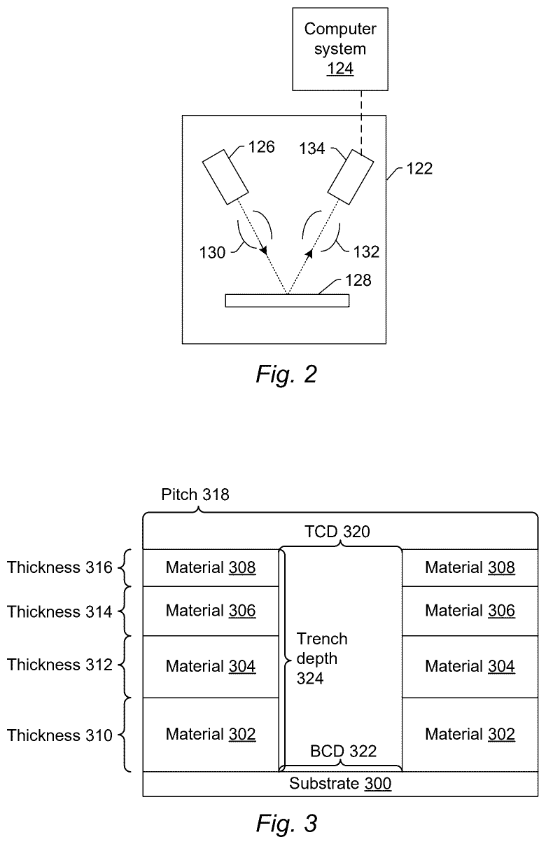

One embodiment of a system configured for determining information for a specimen is shown in FIG. 1. In one embodiment, the system includes a metrology subsystem configured for illuminating a target structure on specimen 126 with an energy source (e.g., one or more of light (as shown in FIG. 1) and electrons (as shown in FIG. 2)) and detecting signals responsive thereto. The metrology subsystem includes and/or is coupled to computer subsystem 152.

In general, the metrology subsystems described herein include at least an energy source, a detector, and a scanning subsystem. The energy source is configured to generate energy that is directed to a specimen by the metrology subsystem. The detector is configured to detect energy from the specimen and to generate output responsive to the detected energy. The scanning subsystem is configured to change a position on the specimen to which the energy is directed and from which the energy is detected.

In one embodiment, the metrology subsystem is configured as a light-based metrology subsystem. FIG. 1 illustrates an embodiment of a system that includes various light-based metrology subsystems. The metrology subsystems shown in FIG. 1 are described in more detail in U.S. Pat. No. 6,515,746 to Opsal et al., which is incorporated by reference as if fully set forth herein. Some of the non-essential details of the system presented in this patent have been omitted from the description corresponding to FIG. 1 presented herein. However, it is to be understood that the system illustrated in FIG. 1 may be further configured as described in this patent. In addition, it will be obvious upon reading the description of several embodiments provided herein that the system illustrated in FIG. 1 has been altered to improve upon the system described in U.S. Pat. No. 6,515,746 to Opsal et al. The alterations include the physics augmented regression algorithm described further herein.

One of the metrology subsystems is configured as a broadband reflective spectrometer. Broadband reflective spectrometer (BRS) 130 simultaneously probes specimen 126 with multiple wavelengths of light. BRS 130 uses lens 132 and includes a broadband spectrometer 134 which can be of any type commonly known and used in the art. Lens 132 may be a transmissive optical component formed of a material such as calcium fluoride (CaF₂). Such a lens may be a spherical, microscope objective lens with a high numerical aperture (on the order of 0.90 NA) to create a large spread of angles of incidence with respect to the specimen surface, and to create a spot size of about one micron in diameter. Alternatively, lens 132 may be a reflective optical component. Such a lens may have a lower numerical aperture (on the order of 0.4 NA) and may be capable of focusing light to a spot size of about 10-15 microns. Spectrometer 134 shown in FIG. 1 includes lens 136, aperture 138, dispersive element 140, and detector array 142. Lens 136 may be formed of CaF₂.

During operation, probe beam 144 from light source 146 is collimated by lens 145, directed by mirror 143 through mirror 166 to mirror 186, which directs the light through mirror 148 to lens 132, which is then focused onto specimen 126 by lens 132. The light source may include any of the light sources described above. Lens 145 may be formed of CaF₂.

Light reflected from the surface of the specimen passes through lens 132 and is directed by mirror 148 (through mirror 150) to spectrometer 134. Lens 136 focuses the probe beam through aperture 138, which defines a spot in the field of view on the specimen surface to analyze. Dispersive element 140, such as a diffraction grating, prism, or holographic plate, angularly disperses the beam as a function of wavelength to individual detector elements contained in detector array 142.

The different detector elements measure the optical intensities of different wavelengths of light contained in the probe beam, preferably simultaneously. Alternately, detector 142 can be a charge-coupled device (“CCD”) camera or a photomultiplier with suitably dispersive or otherwise wavelength selective optics. It should be noted that a monochrometer could be used to measure the different wavelengths serially (one wavelength at a time) using a single detector element. Further, dispersive element 140 can also be configured to disperse the light as a function of wavelength in one direction, and as a function of the angle of incidence with respect to the specimen surface in an orthogonal direction, so that simultaneous measurements as a function of both wavelength and angle of incidence are possible. Computer subsystem 152 processes the intensity information measured by detector array 142.

Broadband spectroscopic ellipsometer (BSE) 154 is also configured to perform measurements of the specimen using light. BSE 154 includes polarizer 156, focusing mirror 158, collimating mirror 160, rotating compensator 162, and analyzer 164. In some embodiments, BSE 154 may be configured to perform measurements of the specimen using light provided by light source 146, light source 183, or another light source (not shown).

In operation, mirror 166 directs at least part of probe beam 144 to polarizer 156, which creates a known polarization state for the probe beam, preferably a linear polarization. Mirror 158 focuses the beam onto the specimen surface at an oblique angle, ideally on the order of 70 degrees to the normal of the specimen surface. Based upon well known ellipsometric principles, the reflected beam will generally have a mixed linear and circular polarization state after interacting with the specimen, based upon the composition and thickness of the specimen's film 168 and substrate 170.

The reflected beam is collimated by mirror 160, which directs the beam to rotating compensator 162. Compensator 162 introduces a relative phase delay 8 (phase retardation) between a pair of mutually orthogonal polarized optical beam components. Compensator 162 is rotated at an angular velocity c about an axis substantially parallel to the propagation direction of the beam, preferably by electric motor 172. Analyzer 164, preferably another linear polarizer, mixes the polarization states incident on it. By measuring the light transmitted by analyzer 164, the polarization state of the reflected probe beam can be determined.

Mirror 150 directs the beam to spectrometer 134, which simultaneously measures the intensities of the different wavelengths of light in the reflected probe beam that pass through the compensator/analyzer combination. Computer subsystem 152 receives the output of detector 142, and processes the intensity information measured by detector 142 as a function of wavelength and as a function of the azimuth (rotational) angle of compensator 162 about its axis of rotation, to solve the ellipsometric values y and A as described in U.S. Pat. No. 5,877,859 to Aspnes et al., which is incorporated by reference as if fully set forth herein.

A system that includes the broadband reflective spectrometer and broadband spectroscopic ellipsometer described above may also include additional metrology subsystem(s) configured to perform additional measurements of the specimen using light. For example, the system may include metrology subsystems configured as a beam profile ellipsometer, a beam profile reflectometer, another optical subsystem, or a combination thereof.

Beam profile ellipsometry (BPE) is discussed in U.S. Pat. No. 5,181,080 to Fanton et al., which is incorporated by reference as if fully set forth herein. BPE 174 includes laser 183 that generates probe beam 184. Laser 183 may be a solid state laser diode from Toshiba Corp. which emits a linearly polarized 3 mW beam at 673 nm. BPE 174 also includes quarter wave plate 176, polarizer 178, lens 180, and quad detector 182. In operation, linearly polarized probe beam 184 is focused on specimen 126 by lens 132. Light reflected from the specimen surface passes up through lens 132 and mirrors 148, 186, and 188, and is directed into BPE 174 by mirror 190.

The position of the rays within the reflected probe beam correspond to specific angles of incidence with respect to the specimen's surface. Quarter-wave plate 176 retards the phase of one of the polarization states of the beam by 90 degrees. Linear polarizer 178 causes the two polarization states of the beam to interfere with each other. For maximum signal, the axis of polarizer 178 should be oriented at an angle of 45 degrees with respect to the fast and slow axis of quarter-wave plate 176. Detector 182 is a quad-cell detector with four radially disposed quadrants that each intercept one quarter of the probe beam and generate a separate output signal proportional to the power of the portion of the probe beam striking that quadrant.

The output signals from each quadrant are sent to computer subsystem 152. By monitoring the change in the polarization state of the beam, ellipsometric information, such as y and A, can be determined. To determine this information, computer subsystem 152 takes the difference between the sums of the output signals of diametrically opposed quadrants, a value which varies linearly with film thickness for very thin films.

Beam profile reflectometry (BPR) is discussed in U.S. Pat. No. 4,999,014 to Gold et al., which is incorporated by reference as if fully set forth herein. BPR 192 includes laser 183, lens 194, beam splitter 196, and two linear detector arrays 198 and 200 to measure the reflectance of the sample. In operation, linearly polarized probe beam 184 is focused onto specimen 126 by lens 132, with various rays within the beam striking the specimen surface at a range of angles of incidence. Light reflected from the specimen surface passes up through lens 132 and mirrors 148 and 186, and is directed into BPR 192 by mirror 188. The position of the rays within the reflected probe beam correspond to specific angles of incidence with respect to the specimen's surface. Lens 194 spatially spreads the beam two-dimensionally. Beam splitter 196 separates the S and P components of the beam, and detector arrays 198 and 200 are oriented orthogonal to each other to isolate information about S and P polarized light. The higher angle of incidence rays will fall closer to the opposed ends of the arrays. The output from each element in the diode arrays will correspond to different angles of incidence. Detectors arrays 198 and 200 measure the intensity across the reflected probe beam as a function of the angle of incidence with respect to the specimen surface. Computer subsystem 152 receives the output of detector arrays 198 and 200, and derives the thickness and refractive index of thin film layer 168 based on these angular dependent intensity measurements by utilizing various types of modeling algorithms. Optimization routines which use iterative processes such as least square fitting routines are typically employed.

The system shown in FIG. 1 may also include additional components such as detector/camera 202. Detector/camera 202 is positioned above mirror 190, and can be used to view reflected beams off of specimen 126 for alignment and focus purposes.

In order to calibrate BPE 174, BPR 192, BRS 130, and BSE 154, the system may include wavelength stable calibration reference ellipsometer 204 used in conjunction with a reference sample (not shown). For calibration purposes, the reference sample ideally consists of a thin oxide layer having a thickness, d, formed on a silicon substrate. However, in general the sample can be any appropriate substrate of known composition, including a bare silicon wafer, and silicon wafer substrates having one or more thin films thereon. The thickness d of the layer need not be known or be consistent between periodic calibrations.

Ellipsometer 204 includes light source 206, polarizer 208, lenses 210 and 212, rotating compensator 214, analyzer 216, and detector 218. Compensator 214 is rotated at an angular velocity y about an axis substantially parallel to the propagation direction of beam 220, preferably by electric motor 222. It should be noted that the compensator can be located either between the specimen and the analyzer (as shown in FIG. 1) or between the specimen and polarizer 208. It should also be noted that polarizer 208, lenses 210 and 212, compensator 214, and polarizer 216 are all optimized in their construction for the specific wavelength of light produced by light source 206, which maximizes the accuracy of the ellipsometer.

Light source 206 produces a quasi-monochromatic probe beam 220 having a known stable wavelength and stable intensity. This can be done passively, where light source 206 generates a very stable output wavelength which does not vary over time (i.e., varies less than 1%). Examples of passively stable light sources are a helium-neon laser, or other gas discharge laser systems. Alternately, a non-passive system can be used where the light source includes a light generator (not shown) that produces light having a wavelength that is not precisely known or stable over time, and a monochrometer (not shown) that precisely measures the wavelength of light produced by the light generator. Examples of such light generators include laser diodes, or polychromatic light sources used in conjunction with a color filter such as a grating. In either case, the wavelength of beam 220, which is a known constant or measured by a monochrometer, is provided to computer subsystem 152 so that ellipsometer 204 can accurately calibrate the optical measurement devices in the system.

Operation of ellipsometer 204 during calibration is further described in U.S. Pat. No. 6,515,746. Briefly, beam 220 enters detector 218, which measures the intensity of the beam passing through the compensator/analyzer combination. Computer subsystem 152 processes the intensity information measured by detector 218 to determine the polarization state of the light after interacting with the analyzer, and therefore the ellipsometric parameters of the specimen. This information processing includes measuring beam intensity as a function of the azimuth (rotational) angle of the compensator about its axis of rotation. This measurement of intensity as a function of compensator rotational angle is effectively a measurement of the intensity of beam 220 as a function of time, since the compensator angular velocity is usually known and a constant.

By knowing the composition of the reference sample, and by knowing the exact wavelength of light generated by light source 206, the optical properties of the reference sample such as film thickness d, refractive index and extinction coefficients, etc., can be determined by ellipsometer 204. Once the thickness d of the film has been determined by ellipsometer 204, then the same sample is probed by the other optical measurement devices BPE 174, BPR 192, BRS 130, and BSE 154 which measure various optical parameters of the sample. Computer subsystem 152 then calibrates the processing variables used to analyze the results from these optical measurement devices so that they produce accurate results. In the above described calibration techniques, all system variables affecting phase and intensity are determined and compensated for using the phase offset and reflectance normalizing factor discussed in U.S. Pat. No. 6,515,746, thus rendering the optical measurements made by these calibrated optical measurement devices absolute.

The above described calibration techniques are based largely upon calibration using the derived thickness d of the thin film. However, calibration using ellipsometer 204 can be based upon any of the optical properties of the reference sample that are measurable or determinable by ellipsometer 204 and/or are otherwise known, whether the sample has a single film thereon, has multiple films thereon, or even has no film thereon (bare sample).

In some embodiments, the metrology subsystems may have at least one common optical component. For example, lens 132 is common to BPE 174, BPR 192, BRS 130, and BSE 154. In a similar manner, mirrors 143, 166, 186, and 148 are common to BPE 174, BPR 192, BRS 130, and BSE 154. Ellipsometer 204, as shown in FIG. 1, does not have any optical components that are common to the other metrology subsystems. Such separation from the other metrology subsystems may be appropriate since the ellipsometer is used to calibrate the other metrology subsystems.

Computer subsystem 152 may be coupled to the detectors of the metrology subsystem in any suitable manner (e.g., via one or more transmission media, which may include “wired” and/or “wireless” transmission media) such that the computer subsystem can receive the output generated by the detectors. Computer subsystem 152 may be configured to perform a number of functions with or without the output of the detectors including the steps and functions described further herein. As such, the steps described herein may be performed “on-tool,” by a computer subsystem that is coupled to or part of a metrology subsystem. In addition, or alternatively, other computer system(s) (not shown) may perform one or more of the steps described herein. Therefore, one or more of the steps described herein may be performed “off-tool,” by a computer system that is not directly coupled to a metrology subsystem. Computer subsystem 152 may be further configured as described herein.

Computer subsystem 152 (as well as other computer subsystems described herein) may also be referred to herein as computer system(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer subsystem, then the different computer subsystems may be coupled to each other such that images, data, information, instructions, etc. can be sent between the computer subsystems. For example, computer subsystem 152 may be coupled to other computer system(s) (not shown) by any suitable transmission media, which may include any suitable wired and/or wireless transmission media known in the art. Two or more of such computer subsystems may also be effectively coupled by a shared computer-readable storage medium (not shown).

The metrology subsystem may be configured to have multiple modes. In general, a “mode” is defined by the values of parameters of the metrology subsystem used to generate output for the specimen. Therefore, modes that are different may be different in the values for at least one of the optical parameters of the metrology subsystem (other than position on the specimen at which the output is generated). For example, for a light-based metrology subsystem, different modes may use different wavelengths of light. The modes may be different in the wavelengths of light directed to the specimen as described further herein (e.g., by using different light sources, different spectral filters, etc. for different modes).

The multiple modes may also be different in illumination and/or collection/detection. Furthermore, the modes may be different from each other in more than one way described herein (e.g., different modes may have one or more different illumination parameters and one or more different detection parameters). The metrology subsystem may be configured to generate output for the specimen with the different modes in the same scan or different scans, e.g., depending on the capability of using multiple modes to generate output for the specimen at the same time.

In the field of semiconductor metrology, a metrology subsystem may include an illumination subsystem which illuminates a target/location, a collection subsystem which captures relevant information provided by the illumination subsystem's interaction (or lack thereof) with a target, device or feature, and a computer subsystem which analyzes the information collected using one or more algorithms. Metrology subsystems can be used to measure structural and material characteristics (e.g., material composition, dimensional characteristics of structures and films such as film thickness and/or critical dimensions (CDs) of structures, overlay, etc.) associated with various semiconductor fabrication processes. These measurements are used to facilitate process control and/or yield efficiencies in the manufacture of semiconductor dies.

The metrology subsystem can include one or more hardware configurations which may be used in conjunction with certain embodiments described herein to, e.g., measure the various aforementioned semiconductor structural and material characteristics. Examples of such hardware configurations include, but are not limited to, the following.
1. Spectroscopic ellipsometer (SE)
2. SE with multiple angles of illumination
3. SE measuring Mueller matrix elements (e.g. using rotating compensator(s))
4. Single-wavelength ellipsometers
5. Beam profile ellipsometer (angle-resolved ellipsometer)
6. Beam profile reflectometer (angle-resolved reflectometer)
7. Broadband reflective spectrometer (spectroscopic reflectometer)
8. Single-wavelength reflectometer
9. Angle-resolved reflectometer
10. Imaging system
11. Scatterometer (e.g. speckle analyzer)

The hardware configurations can be separated into discrete operational systems. On the other hand, one or more hardware configurations can be combined into a single tool. One example of such a combination of multiple hardware configurations into a single tool is shown in FIG. 1, which may be further configured as described in U.S. Pat. No. 7,933,026 to Opsal et al., which is incorporated by reference as if fully set forth herein. The systems described herein may be further configured as described in this reference.

FIG. 1 shows, for example, a schematic of an exemplary metrology subsystem that comprises: a) a broadband SE (i.e., 154); b) a SE (i.e., 204) with rotating compensator (i.e., 214); c) a beam profile ellipsometer (i.e., 174); d) a beam profile reflectometer (i.e., 192); e) a broadband reflective spectrometer (i.e., 130); and f) a deep ultraviolet reflective spectrometer (i.e., 130). In addition, there are typically numerous optical elements in such systems, including certain lenses, collimators, mirrors, quarter-wave plates, polarizers, detectors, cameras, apertures, and/or light sources. The wavelengths for optical systems can vary from about 120 nm to 3 microns. For non-ellipsometer systems, signals collected can be polarization-resolved or unpolarized. FIG. 1 provides an illustration of multiple metrology heads integrated on the same tool. However, in many cases, multiple metrology subsystems are used for measurements on a single or multiple metrology targets, which is described, e.g. in U.S. Pat. No. 7,478,019 to Zangooie et al., which is incorporated by reference as if fully set forth herein. The embodiments described herein may be further configured as described in this reference.

The illumination subsystem of the certain hardware configurations includes one or more light sources. The light source(s) may generate light having only one wavelength (i.e., monochromatic light), light having a number of discrete wavelengths (i.e., polychromatic light), light having multiple wavelengths (i.e., broadband light) and/or light that sweeps through wavelengths, either continuously or hopping between wavelengths (i.e., tunable sources or swept sources). Examples of suitable light sources include, but are not limited to, a white light source, an ultraviolet (UV) laser, an arc lamp or an electrode-less lamp, a laser sustained plasma (LSP) source such as those commercially available from Energetiq Technology, Inc., Woburn, Massachusetts, a supercontinuum source (such as a broadband laser source) such as those commercially available from NKT Photonics Inc., Morganville, New Jersey, or shorter-wavelength sources such as x-ray sources, extreme UV sources, or some combination thereof. The light source may also be configured to provide light having sufficient brightness, which in some cases may be a brightness greater than about 1 W/(nm cm² Sr). The metrology subsystem may also include a fast feedback to the light source for stabilizing its power and wavelength. Output of the light source can be delivered via free-space propagation, or in some cases delivered via optical fiber or light guide of any type.

The metrology subsystem may be designed to make many different types of measurements related to semiconductor manufacturing. Certain embodiments described herein may be applicable to such measurements. For example, in certain embodiments, the subsystem may measure characteristics of one or more targets (more generally and interchangeably referred to herein as “one or more structures”), such as critical dimensions, overlay, sidewall angles (SWAs), film thicknesses, process-related parameters (e.g., focus and/or dose). The targets can include certain regions of interest that are designed to be periodic in nature such as, for example, gratings in a memory die. Targets can include multiple layers (or films) whose thicknesses can be measured by the metrology subsystem. Targets can include target designs placed (or already existing) on the specimen for use, e.g., with alignment and/or overlay registration operations. Certain targets can be located at various places on the specimen. For example, targets can be located within the scribe lines (e.g., between dies) and/or located in the die itself. In certain embodiments, multiple targets are measured (at the same time or at differing times) by the same or multiple metrology tools as described in U.S. Pat. No. 7,478,019 to Zangooie et al. The data from such measurements may be combined. Data from the metrology subsystem is used in the semiconductor manufacturing process for example to feed-forward, feed-backward and/or feed-sideways corrections to the process (e.g. lithography, etch) and therefore, might yield a complete process control solution.

As described above, the metrology subsystem may be configured for generating output for the specimen with one or more wavelengths of light. In addition, the metrology subsystem may be configured for generating output for the specimen with other electromagnetic radiation such as x-rays. In such instances, some obvious modifications to the system described above may be made but such modifications are within the ordinary skill in the art. In addition, the metrology subsystem described above may be further configured as described in U.S. Pat. No. 7,929,667 to Zhuang et al., U.S. Pat. No. 9,885,962 to Veldman et al., U.S. Pat. No. 10,013,518 to Bakeman et al., U.S. Pat. No. 10,324,050 to Hench et al., and U.S. Pat. No. 10,352,695 to Gellineau et al. and U.S. Patent Application Publication Nos. 2018/0106735 to Dziura et al. and 2019/0017946 to Wack et al., all of which are incorporated by reference as if fully set forth herein. The embodiments described herein may be further configured as described in these publications.

The metrology subsystem may also or alternatively be configured as an electron beam or other charged particle metrology subsystem. In an electron beam metrology subsystem, the energy directed to the specimen includes electrons, and the energy detected from the specimen includes electrons. In one such embodiment shown in FIG. 2, the metrology subsystem includes electron column 122, and the system includes computer system 124 coupled to the metrology subsystem. Computer system 124 may be configured as described above. In addition, such a metrology subsystem may be coupled to another one or more computer systems in the same manner described above and shown in FIG. 1.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam metrology subsystem may be configured to use multiple modes to generate output for the specimen as described further herein (e.g., with different illumination angles, collection angles, etc.). The multiple modes of the electron beam metrology subsystem may be different in any electron beam related parameters of the metrology subsystem.

Computer system 124 may be coupled to detector 134 as described above. The detector may detect electrons returned from the surface of the specimen thereby forming electron beam images of (or other output for) the specimen. The electron beam images may include any suitable electron beam images. Computer system 124 may be configured to perform any step(s) described herein. A system that includes the metrology subsystem shown in FIG. 2 may be further configured as described herein.

FIGS. 1 and 2 are provided herein to generally illustrate configurations of a metrology subsystem that may be included in the system embodiments described herein. Obviously, the metrology subsystem configurations described herein may be altered to optimize the performance of the metrology subsystem as is normally performed when designing a commercial metrology system. In addition, the systems described herein may be implemented using an existing metrology system (e.g., by adding functionality described herein to an existing metrology tool) such as the tools that are commercially available from KLA Corp., Milpitas, Calif. For some such systems, the methods described herein may be provided as optional functionality of the metrology tool (e.g., in addition to other functionality of the metrology tool). Alternatively, the metrology tool described herein may be designed “from scratch” to provide a completely new system.

Although the metrology subsystem is described above as being a light or electron beam metrology subsystem, the metrology subsystem may be an ion beam metrology subsystem. Such a metrology subsystem may be configured as shown in FIG. 2 except that the electron beam source may be replaced with any suitable ion beam source known in the art. In addition, the metrology subsystem may include any other suitable ion beam system such as those included in commercially available focused ion beam (FIB) systems, helium ion microscopy (HIM) systems, and secondary ion mass spectroscopy (SIMS) systems.

As noted above, the metrology subsystem is configured for directing energy (e.g., light, electrons, etc.) to and detecting energy from a physical version of the specimen thereby generating output for the physical version of the specimen. In this manner, the metrology subsystem may be configured as an “actual” tool, rather than a “virtual” tool. However, a storage medium (not shown) and computer subsystem 152 shown in FIG. 1 may be configured as a “virtual” system. In particular, the storage medium and the computer subsystem may be configured as a “virtual” metrology tool as described in commonly assigned U.S. Pat. No. 8,126,255 issued on Feb. 28, 2012 to Bhaskar et al. and U.S. Pat. No. 9,222,895 issued on Dec. 29, 2015 to Duffy et al., which are incorporated by reference as if fully set forth herein. The embodiments described herein may be further configured as described in these patents.

The system includes a computer system, which may include any configuration of any of the computer subsystem(s) or system(s) described above, and one or more components executed by the computer system. For example, as shown in FIG. 1, the system may include computer subsystem 152 and one or more components 153 executed by the computer subsystem. The one or more components include physics augmented regression algorithm 155 configured as described herein.

The term “target structure” is used interchangeably herein with the term “target.” In general, the term “target structure” is defined herein as features in a design for a specimen that are formed on the specimen in a fabrication process. The term “target structure” is also used herein to refer to the design features that are patterned on the specimen as opposed to unpatterned layers included in some designs. The “target structure” described herein is therefore commonly formed on specimens such as those described herein in processes like lithography and/or etch. In addition, some defects or foreign material (like particles, fall-on materials, and residual materials) may be considered target structures on a specimen. For example, the term “target structure” as used herein refers to structures intentionally or unintentionally formed on the specimen in one or more steps of a fabrication process. In other words, although the embodiments described herein are particularly advantageous for determining characteristics of relatively large pitch, relatively deep patterned structures, the embodiments may be used to determine one or more physical characteristics of any structure of interest on the specimen.

The computer subsystem is configured for inputting the detected signals for the specimen into the physics augmented regression algorithm. Inputting the detected signals may include acquiring the detected signals generated by the metrology subsystem. Acquiring the detected signals may include simply generating signals for the specimen using a metrology subsystem described herein. Acquiring the detected signals generated for the specimen may, however, be performed without the metrology subsystem. For example, the detected signals may be acquired from a storage medium (such as one of those described further herein) in which the detected signals have been stored by another system or method. The computer subsystem may be configured to input the detected signals into the physics augmented regression algorithm in any suitable manner known in the art.

In any of such cases, the detected signals for the specimen may include simply signals for the specimen generated by detector(s) of the metrology subsystem. Acquiring the detected signals for the specimen may, however, include performing any suitable processing known in the art on the signals generated by detector(s) of the metrology subsystem. In this manner, the detected signals for the specimen may simply be the raw signals generated by the metrology subsystem or may have been processed in some manner (e.g., to reduce noise in the signals). The signal processing may include any signal processing normally used in metrology processes.

The input to the physics augmented regression algorithm may include the detected signals possibly in combination with any other information needed by or useful to the physics augmented regression algorithm. For example, the computer subsystem may also input the predicted signals for the target structure. The computer subsystem may generate the predicted target signals in any suitable manner known in the art such as with a rigorous coupled-wave analysis (RCWA) algorithm or with an electromagnetic magnetic (EM) engine based on geometric optics and/or specifically suited for relatively large pitch targets such as those described herein. One particularly suitable EM engine for generating predicted target signals for the embodiments described herein is described in P6342, which is incorporated by reference as if fully set forth herein. The embodiments described herein may be further configured as described in this publication. In some embodiments, the physics augmented regression algorithm may be configured to generate the predicted signals for the target structure, e.g., by incorporation of an EM engine into the regression algorithm configuration. “Predicted signals” may be used interchangeably herein with the term “simulated signals” and is generally defined as signals that would be generated by the metrology subsystem with a given set of hardware (and possibly software) parameters for a target structure having a given set of physical characteristics.

In addition to the new physics augmented regression algorithm, the embodiments described herein may also use a target model for the target structures for which the embodiments are most advantageous and a multi-pass type regression to extract the CD parameters of the relatively large pitch targets described herein.

Qualifying terms like “large pitch,” “deep structure,” and “high-frequency, small-amplitude” as used herein relate to a concept known as “electrical size.” Electrical size is the relative relationship between a scatterer, object, or dimension with respect to the wavelength of light interacting with it. While all interactions of light are described, classically, by Maxwell's Equations, the electrical size of a problem can dictate approximate forms of solutions to Maxwell's Equations. For example, Kirchoff's Law is a generalization of Gauss' Law for substantially small electrical sizes in circuits.

In one embodiment, the target structure includes a large pitch target that causes high-frequency, small amplitude oscillations in the detected signals. A “large pitch” as that term is used herein is generally defined as a dimension greater than 10-100 wavelengths. For example, if the embodiments described herein use wavelengths of 500 nm in spectroscopy and the pitch is 20 microns, then the pitch is 40 wavelengths and would be considered “large” in the context of the embodiments described herein. In addition, a periodic pitch in the embodiments described herein may have no upper bound as the embodiments can handle a single cell target that is non-periodic. In this manner, the physics augmented regression algorithm may be configured as a large pitch algorithm.

The target structure embodiments described herein may also be deep structures. A “deep” structure as that term is used herein can be generally defined as a target structure having a depth between 10 um and 110 um or more. For example, a depth of 20 microns would be considered “deep” in the context of the embodiments described herein. The depths of the target structures, whose physical characteristic(s) are determined as described herein, are also specific to the targets generated by the industry for various structures. In general, the embodiments may be configured to determine physical characteristic(s) of target structures of any depth, which may vary depending on the ability of the measurement hardware more than the embodiments described herein. The deep structures described herein also may or may not be deep trenches, where “deep trench” is an industry term that is more likely to do with the size of the depth with respect to the lithographic dimensions (i.e., 50 microns deep for memory pitches that are 200 nm). Under the circumstances of “large” pitch, a different set of approximate methods may be used while retaining accuracy than if the pitch is on the order of the wavelengths involved (i.e., 20-1000 nanometers).

In one such example, the embodiments described herein can be configured to extract the deep CD of large pitch targets. The large pitch targets in question can have a trench or hole depth between 10 um and 110 um, a periodic pitch up to 40 um, and a film stack above, below, or amongst the CD of interest that includes multiple layers with various materials and various thicknesses. The light used to measure the structure can vary from 150 nm to 2.5 um. If shorter wavelengths are used, then the large pitch of the structures deemphasizes the influence of adjacent periodic cells. In this manner, the periodic properties of the problem can be ignored, which opens the possibilities to new electromagnetic (EM) engines.

The physics augmented regression algorithm executed by the computer subsystem includes a regression algorithm and an objective function. The objective function is configured for separation of relationships between the detected signals and different physical characteristics of the target structure. For the physics augmented regression algorithm, three novel objective functions are introduced, each rooted in an understanding of the physical characteristics inherent to the class of the large pitch targets. These functions are designed to overcome the accuracy and precision issues that the chi-square-based regression algorithm has for the target structures described herein. The physics augmented regression algorithm is configured for determining one or more of the different physical characteristics of the target structure from the inputted detected signals.

In one embodiment, the objective function includes a phase counting difference objective function determined as a discrepancy in phase counts between the detected signals and predicted signals generated for the target structure by the regression algorithm. For example, the phase counting difference objective function involves a meticulous analysis of the oscillatory nature of both the target and predicted signals within the wavelength domain. Specifically, the total number of oscillations present in these signals is quantified as described further herein. The discrepancy in the phase count between the target and predicted signals is then employed as the objective function. This approach allows for a nuanced assessment of the predictive model's accuracy in capturing the oscillatory behavior inherent to the target signal.

The term “k-space” as used herein is generally defined as a transformed space that can be created by techniques such as Fast Fourier Transform (FFT), but also not just FFT. In particular, there is freedom in how the signals are transformed and processed in the embodiments described herein. For example, FFT or a different transformation like discrete cosine transform (DCT) may be used in the embodiments described herein. In addition, the embodiments may transform the signal in the wavenumber or eV space instead of the wavelength space.

In another embodiment, the objective function includes a k-space intensity difference objective function determined by transforming the detected signals and predicted signals generated for the target structure by the regression algorithm to k-space and determining an intensity difference between the detected signals and the predicted signals within one or more specified ranges of the k-space. For example, the k-space intensity difference objective function may apply a series of signal transformations to the detected signals culminating in applying the FFT. This process facilitates the transition of the detected signals from the wavelength space to the k-space. Subsequently, the intensity difference between the detected and predicted signals is evaluated within specified range(s) of the k-space. This intensity difference serves as the objective function for the regression algorithm.

In a further embodiment, the objective function includes a k-space unwrapped phase slope difference objective function determined by transforming the detected signals and predicted signals generated for the target structure by the regression algorithm to k-space and determining a difference in unwrapped phase slope between the detected signals and the predicted signals over one or more specified ranges within the k-space. For example, the k-space unwrapped phase slope difference objective function utilizes the FFT to convert the detected signals from the wavelength domain to the k-space. Following this transformation, the difference in the unwrapped phase slope between the detected and predicted signals is computed over specified range(s) within the k-space. This difference is then employed as the objective function in the regression algorithm.

In some embodiments in which the objective function includes a k-space intensity difference or k-space unwrapped phase slope difference objective function, the physics augmented regression algorithm is configured for estimating an initial depth value for the target structure and determining the one or more specified ranges based on the initial depth value. For example, additional innovation for these two objective functions lies in the strategic determination of specific k-space range(s). This approach may be particularly advantageous to the methodology described herein, recognizing that the performance of the regression analysis may be significantly influenced by the selection of k-space regions that are analyzed. Through their research, the inventors have found a novel approach that leverages the physical properties of depth parameters in target analysis to enhance the efficiency of regression algorithms. By developing a method for accurately estimating an initial depth value, also referred to herein as the “starting seed,” the inventors have found a way to expedite the convergence process of the regression algorithm.

In a further embodiment, the physics augmented regression algorithm is configured for determining the one or more of the different physical characteristics in a multi-pass regression that includes multiple regression steps. For example, in a multi-pass regression strategy setup, the physics augmented regression approach is particularly suited for depth parameter regression, where the parameter's influence on shifting the signal's peak location in the wavelength spectrum horizontally is addressed with precision through the novel objective function embodiments: phase counting, k-space intensity difference, and k-space unwrapped phase slope difference. Therefore, the new objective functions are used when regressing the depth. As described further herein, different steps of the multi-pass regression may involve floating different parameters of the target structure, and different regression steps may advantageously use different objective functions. In addition, each of the different regression steps may use the same regression algorithm, e.g., the N2X algorithm, with different floating parameters and possibly different objective functions.

In some embodiments, the determined one or more of the different physical characteristics include a BCD of the target structure, and the separation of the relationships between the detected signals and the different physical characteristics of the target structure for which the objective function is configured reduces error in the determined BCD due to variations in a depth parameter for the target structure. For example, application of the k-space intensity difference objective function in BCD parameter regression provides a distinct advantage over currently used chi-square methods by minimizing the error impact from depth parameter variations, thereby significantly enhancing BCD parameter estimation accuracy, for at least the reasons described further herein.

The physics augmented regression algorithm can work on different shapes of large pitch targets. Two specific such targets are described herein, but the embodiments are obviously not limited to these two targets.

In one embodiment, the target structure includes a deep trench that causes high-frequency, small-amplitude oscillations in the detected signals. High-frequency in the embodiments described herein is defined with respect to the modulated sinusoidal component of the spectra. The spectra has two basic properties, a slow varying component and a “high-frequency” oscillation that is modulated on the slow component. In this case, the slow component changes over the span of 100's of nanometers while the high frequency oscillation has a period of nanometers. Small-amplitude refers to the peak-to-peak amplitude of this modulation compared with the overall signal's reflectivity. In general, the signal may have a reflectively around 0.3-0.7, but the amplitude of high-frequency oscillation may be fractions of that, e.g., 0.01 or smaller.

One example of a model of a rectangular deep trench target is shown in FIG. 3. This target can be adequately represented as a two-dimensional (2D) structure since the gratings usually have no variations in the y direction. The target has a pitch 318 and a top trench width, the TCD 320. Multiple film layers are formed on the top surface of substrate 300, with each layer having its own material and thickness. For example, as shown in FIG. 3, the trench may be formed in a stack of material layers formed on substrate 300 that includes materials 302, 304, 306, and 308, each having its own material and thicknesses 310, 312, 314, and 316, respectively. The trench region is typically air, but is not restricted to other materials, and has shape parameters including BCD 322 and depth 324. The goal of systems and methods such as those described herein is to extract the trench depth and the BCD.

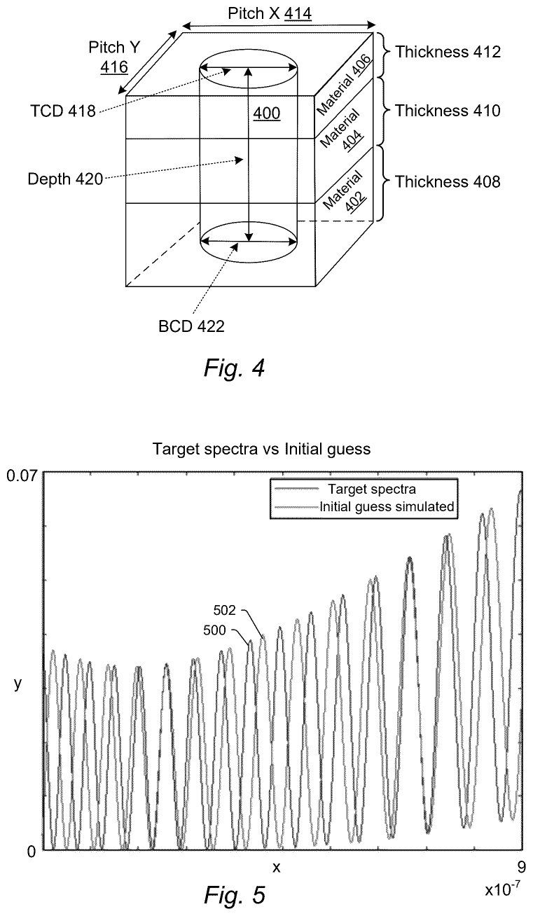

In another embodiment, the target structure includes a TSV that causes high-frequency, small-amplitude oscillations in the detected signals. FIG. 4 illustrates an example model of a TSV target. In general, the TSV model may be configured as a three-dimensional (3D) hole-shaped target. The top view of the target is shown as a rectangular sheet with hole 400 in the middle of the sheet. The hole may have pitch 414 in the X direction and pitch 416 in the Y direction. The hole is typically filled with air but any material can be used. Directly underneath the top surface is a stack of multiple film layers, with each layer having its own material and thickness. For example, as shown in FIG. 4, the stack of materials may include materials 402, 404, and 406, having thicknesses 408, 410, and 412, respectively. The parameters for this target are the thicknesses for each film layer, the top hole diameter (TCD) 418, the hole depth 420, and the bottom hole diameter (BCD) 422. The goal is to extract the hole depth value and the BCD.

Although certain numbers of layers are shown in FIGS. 3 and 4, the number of layers may vary depending on the device being formed, and the relatively thicknesses of the material layers shown in FIGS. 3 and 4 are not meant to be illustrative of any actual devices. One or more of the layers may have (or be designed to have) the same material composition, or each of the layers may be formed of different materials. In addition, although the depths of the targets are shown in FIGS. 3 and 4 as being the same as the combined thicknesses of the film layers, the depth is not necessarily equal to total film layer thickness. In particular, target structure depth can be different than and independent of the film layer thicknesses.

In one embodiment, the regression algorithm includes a gradient-based nonlinear regression algorithm. For example, for single-pass regression, the physics augmented regression algorithm may use the iterative gradient-based regression algorithm called the N2X algorithm. The N2X algorithm is an adaptive nonlinear least-squares algorithm. This regression algorithm may be configured as described in, for example, Dennis et al., “An Adaptive Nonlinear Least Squares Algorithm,” ACM Trans. Math. Software 7 (1981), pp. 348-368 and 369-383, which is incorporated by reference as if fully set forth herein. The embodiments described herein may be further configured as described in this reference. In addition, the regression algorithm may include any other suitable gradient-based regression algorithm known in the art that can apply (or can be configured to apply) the physics based objective function(s) described herein. For the embodiments described herein, the inputs for the algorithm include all the CD parameters for the large pitch target, and the user, the recipe, or the computer subsystem can determine which CD parameters will be floated.

In contrast to current uses of the N2X algorithm, which employ the chi-square as the objective function to quantify the signal difference across wavelengths (an objective function sometimes referred to as “wavelength space signal difference”), the novel physics augmented regression algorithm embodiments described herein introduce three innovative objective functions designed to capture the physical characteristics of the target.

The first new objective function is the phase counting difference objective function, which quantifies the oscillation behavior of signals by counting the number of oscillations within a given wavelength range thereby offering a direct measurement of phase discrepancies between the predicted and detected target signals.

The second new objective function, the k-space intensity difference, involves a transformation of signals to the k-space via FFT and assesses the intensity differences within specific k-space region(s), facilitating a focus on spatial frequency discrepancies.

The third new objective function, the k-space unwrapped phase slope difference, also utilizes FFT to analyze signals in the k-space but focuses on the unwrapped phase slop differences, targeting phase behavior in a distinct spatial frequency domain.

These objective functions collectively enhance the algorithm's sensitivity to the physical properties of the signal, promising a significant improvement over the currently used chi-square objective functions.

Procedures and equations that can be used to calculate these three objective functions are as follows:

The algorithm first preprocesses the spectra in the wavelength space and then applies the FFT to get the signal in the k-space by detrending the input signal in the wavelength domain to slope equals 0 and applying a discrete Blackman-Harris window to the detrended signal. The algorithm may also zero pad the windowed signal to make the signal size equal to the k-space window size. We denote the signal as Sₚᵣₑₚ. The algorithm then may apply FFT on the Sₚᵣₑₚ to generate the transformed signal in the k-space:

$${S}_{N} = FFT ( {S}_{PreP} , {N}_{Window} )$$

where N_{Window} is the total sample points number in the Fourier transform. The algorithm may then calculate the intensity of the transformed signal:

$${I}_{N} = ‖ {S}_{N} ‖$$

In addition, the algorithm may generate the unwrapped phase of the transformed signal:

$${ϕ}_{N}^{Un} = unwrap ( Phase ( {S}_{N} ) )$$

Over a bandwidth of size λ_{BW} that contains N_{BW} sampling points, i.e., N_{BW} is the total number of sample points in the selected wavelength range, a desired wavelength, λᵢ, can be mapped to its corresponding k-space value.

$${k}_{index} ( d , {λ}_{i} , {λ}_{BW} ) = \frac{2 \cdot d - {λ}_{i}}{{λ}_{i}^{2}} \cdot \frac{{N}_{Window} \cdot {λ}_{BW}}{{N}_{BW}} \qquad ( 1 )$$

where d is the target structure depth value. The k-space range can then be determined using equation (1). For the k-space range selection, to determine the k-space start index, the end wavelength value is used as the input wavelength and the nominal depth value as the input depth, then those values are plugged into equation (1) to calculate the k-space start index.

$${k}_{index , start} ( {d}_{Nom} , {λ}_{{N}_{BW}} , {λ}_{BW} ) = \frac{2 \cdot {d}_{Nom} - {λ}_{{N}_{BW}}}{{λ}_{{N}_{BW}}^{2}} \cdot \frac{{N}_{Window} \cdot {λ}_{BW}}{{N}_{BW}}$$

For the k-space range selection, to determine the k-space end index, we use the start wavelength value as the input wavelength and the nominal depth value as the input depth, then plug in those values to equation (1) to calculate the k-space end index.

$${k}_{index , end} ( {d}_{Nom} , {λ}_{1} , {λ}_{BW} ) = \frac{2 \cdot {d}_{Nom} - {λ}_{1}}{{λ}_{1}^{2}} \cdot \frac{{N}_{Window} \cdot {λ}_{BW}}{{N}_{BW}}$$

The k-space intensity peak index is found within the k-space range of interest. Finding the k-space intensity peak index can be done by scanning through the k-space intensities between the k-space start index and the k-space end index inclusively.

$${k}_{index , peak} ( {d}_{Nom} , {λ}_{BW} ) = arg {max}_{{k}_{i}} ( {I}_{N} ( {k}_{i} ) )$$

where I_{N}(kᵢ) is the intensity array (list) in the Fourier domain between the index k_{index,start} and k_{index,end}.

The estimated wavelength range for one complete phase shift due to reflections from the bottom of the structure (the trench bottom or the TSV bottom) and from the top of the structure (the top film layer) are calculated.

$${λ}_{BW , PS} = \frac{{N}_{Window}}{{k}_{index , peak}} \cdot \frac{{λ}_{BW}}{{N}_{BW}}$$

The phase counting function is calculated:

$${S}_{PC} = \frac{{λ}_{Sim , BW}}{{λ}_{Sim , BW , PS}} \qquad ( 2 )$$

The intensity in k-space function is calculated:

$${I}_{N} [ {k}_{i} ] = ‖ {S}_{N} ‖ [ {k}_{i} ] \qquad ( 3 )$$

The k-space unwrapped phase slope function is calculated.

$${Δ}_{N}^{Un} ( {k}_{i} , {k}_{j} ) = \frac{{ϕ}_{N}^{Un} [ {k}_{j} ]}{{ϕ}_{N}^{Un} [ {k}_{i} ]} \qquad ( 4 )$$

The physical depth seed value is calculated:

$${d}_{Seed} = {( \frac{2}{{λ}_{Mid}} - \frac{2}{{λ}_{Mid} + {λ}_{BW , PS}} )}^{- 1} \qquad ( 5 )$$

where λ_{Mid} is the middle wavelength in the selected wavelength range in the wavelength domain.

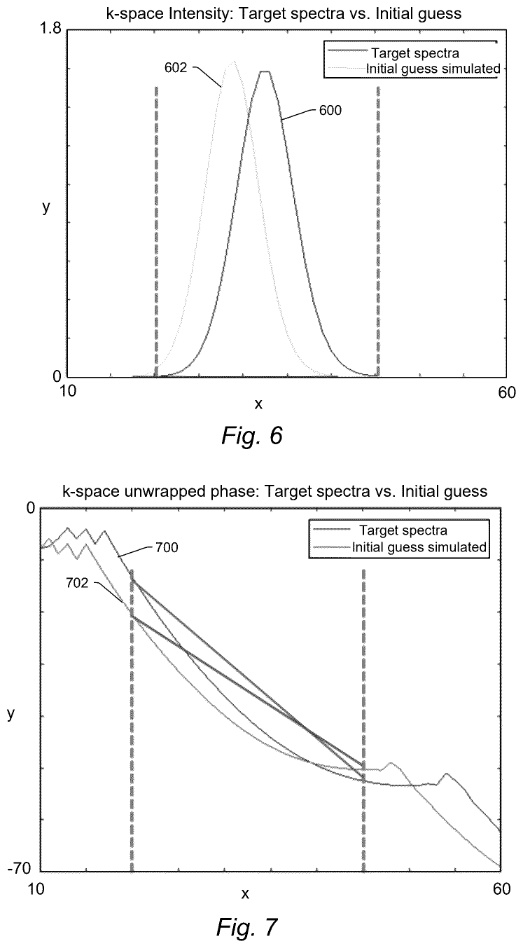

FIG. 5 shows a comparison of spectroscopic reflectometry (SR) simulations for different depths. The signal in the wavelength space, line 500, is the detected target spectra signal. Line 502 is the predicted target signal. As shown in FIG. 5, when the depth is different, the spectra signal peaks shift horizontally in the wavelength space, and there are lots of oscillations. Applying equation (3), the k-space intensity signal can be found, as shown in FIG. 6. In particular, FIG. 6 shows a comparison of intensity plots for target spectra 600 and initial guess simulated 602 as a function of different depths. In viewing the signal intensity in the k-space, there are not any oscillations. With equation (4), the k-space unwrapped phase signal can be found, as shown in FIG. 7. In particular, FIG. 7 shows a comparison of the phase slopes for target spectra 700 and initial guess simulated 702 as a function of different depths. The slope of line 700 is the phase change speed for the detected target spectra, the slope of line 702 is the phase change speed for the predicted target spectra using the initial guess.

Finally, equations (2), (3), and (4) are used to calculate the new objective functions for the regression algorithm, noting the k-space starting and k-space ending indices are the ones calculated from the detected target spectrum, not the simulated spectrum during the regression. Equations (6), (7), and (8) are the definitions of the three new objective functions, the phase counting difference, k-space intensity difference, and k-space unwrapped phase slope difference objective functions, respectively:

$${r}_{PC}^{2} = {( {s}_{Meas , PC} - {s}_{Sim , PC} )}^{2} \qquad ( 6 )$$

$${r}_{I}^{2} = {\sum }_{i = {k}_{index , start}}^{{k}_{index , end}} {( {I}_{Meas , N} [ {k}_{i} ] - {I}_{Sim , N} [ {k}_{i} ] )}^{2} \qquad ( 7 )$$

$${r}_{Δ}^{2} = {( {Δ}_{Meas , N}^{Un} ( {k}_{index , start} , {k}_{index , end} ) - {Δ}_{Sim , N}^{Un} ( {k}_{index , start} , {k}_{index , end} ) )}^{2} \qquad ( 8 )$$

For a design of experiments (DOE) tracking scan of different depth values, the chi-square calculation, the phase counting objective function in equation (6), the k-space intensity objective function in equation (7), or the k-space unwrapped phase slope objective function in equation (8) is applied. Then, plotting the root mean square error (RMSE) for each objective function along the depth scan, the quality of the regression based on the resulting cost function plots can be calculated.

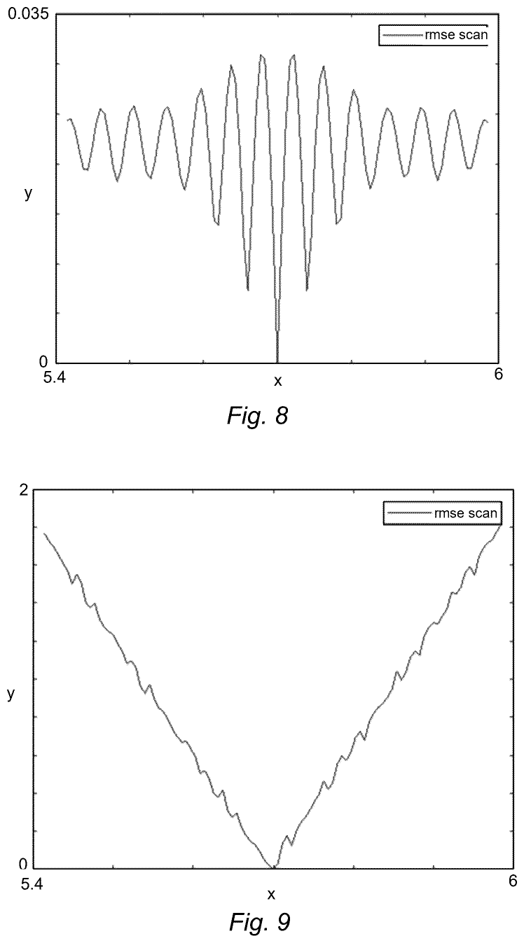

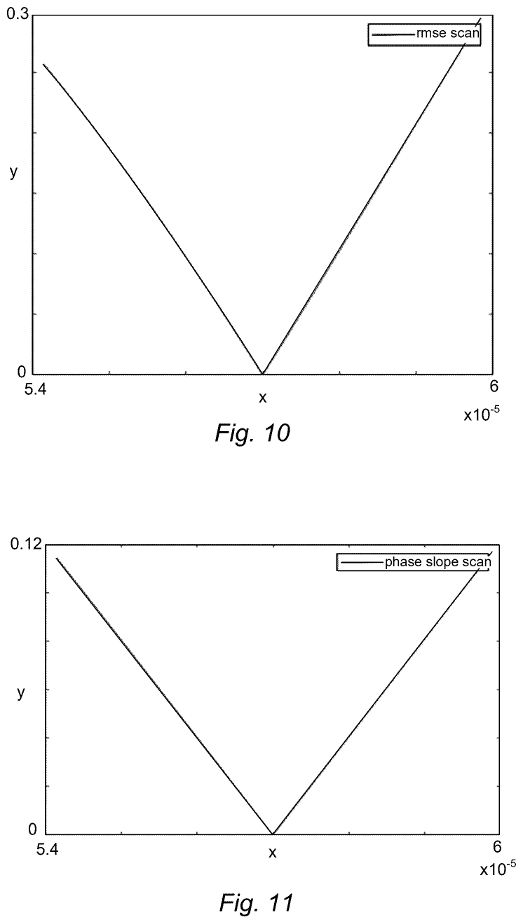

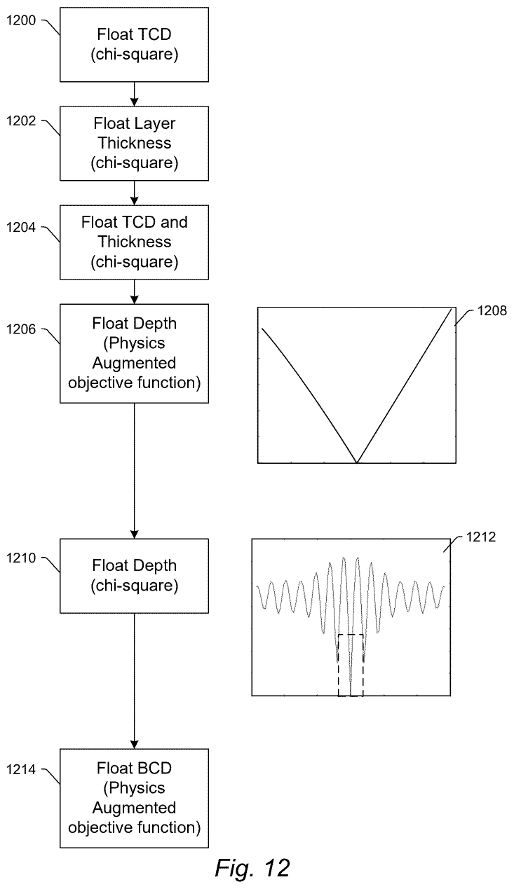

Using the chi-square objective function surface (as currently performed), the presence of 13 local minima for this test case are seen as shown in FIG. 8. In particular, FIG. 8 shows the chi-square cost function as a function of depth. These local minima will lead to outlier results when using the gradient-based regression algorithm. FIG. 9 shows the phase counting cost function as a function of depth. Using the phase counting objective function surface, FIG. 9 shows that the local minima are still present but far less prominent compared to the chi-square objective function. FIG. 10 shows k-space intensity cost function as a function of depth. For the k-space intensity objective function surface, FIG. 10 shows that there is one global minimum with a smooth cost function surface. This suggests that this objective function is good for the gradient-based regression algorithm. Experimental results described further herein also prove this. FIG. 11 shows k-space unwrapped phase slope cost function as a function of depth. For the k-space unwrapped phase slope objective function surface, FIG. 11 shows that there is one global minimum, and the cost function is smooth. This suggests this objective function is also good for the gradient-based regression algorithm, which also aligns with the experimental results described further herein.

As mentioned above, the physics augmented regression algorithm may be configured for determining the one or more of the different physical characteristics in a multi-pass regression that includes multiple regression steps. FIG. 12 illustrates one embodiment of a multi-pass regression algorithm/strategy. In one embodiment, a first of the multiple regression steps includes floating only a TCD of the target structure and determining the TCD with the regression algorithm and a chi-square objective function. For example, as shown in step 1200 of FIG. 12, the multi-pass regression strategy may include floating the TCD on the first pass and fixing other parameters. The objective function used in this step may be the chi-square objective function. In another embodiment, a second of the multiple regression steps includes floating only thickness of one or more films in which the target structure is formed and determining the thickness with the regression algorithm and the chi-square objective function. As shown in step 1202 of FIG. 12, for example, the multi-pass regression strategy may include floating the film layer thickness and fixing other parameters in the second step. This step may also use the chi-square objective function. In a further embodiment, a third of the multiple regression steps includes floating only the TCD and the thickness and determining the TCD and the thickness with the regression algorithm and the chi-square objective function. As shown in step 1204, for example, the multi-pass regression strategy may include floating TCD and film layer thickness together, fixing other parameters, and using the chi-square objective function.

In an additional embodiment, a fourth of the multiple regression steps includes floating only depth of the target structure and determining the depth with the regression algorithm and the objective function. As shown in step 1206, for example, the fourth step may include floating the depth and using one of the physics augmented objective functions described herein such as the k-space intensity or k-space unwrapped phase slope objective function in the regression (both shown generally in FIG. 12 by cost function 1208 as a function of depth). This step may also use the physical depth seed (e.g., determined using equation (5)) as the regression starting value. The depth found in this step may be the global optimal for the depth.

In a further embodiment, a fifth of the multiple regression steps includes floating only the depth and redetermining the depth with the regression algorithm, the chi-square objective function, and the depth determined in the fourth of the multiple regression steps as a regression starting value. For example, as shown in step 1210, the fifth step may include floating the depth, starting with the last pass' depth result, and using the chi-square (shown generally in FIG. 12 as cost function 1212 as a function of depth) to improve the precision. This step is optional if the precision has already reached the requirement. In other words, improving the depth precision via step 1210 is optional if the physics augmented regression algorithm is capable of or has already achieved good depth precision in step 1206.

In some embodiments, a sixth of the multiple regression steps includes floating only a BCD of the target structure and determining the BCD with the regression algorithm and the objective function. This step is the sixth step in cases in which the depth is redetermined in the fifth step or the fifth step in cases in which the depth is not redetermined. As shown in step 1214, for example, the sixth (or fifth) step includes floating the BCD and using the physics augmented objective function. The physics augmented objective function used in this step may be the same as the physics augmented objective function used in the fourth step. For example, both of steps 1206 and 1214 may use the k-space intensity objective function. However, steps 1206 and 1214 may use different physics augmented objective functions. In one such embodiment, a sixth (or fifth) of the multiple regression steps includes floating only a BCD of the target structure and determining the BCD with the regression algorithm and a different objective function configured for the separation of the relationships between the detected signals and the different physical characteristics of the target structure. For example, the fourth regression step (1206) may use the k-space unwrapped phase slope objective function, and the sixth (or fifth) regression step (1214) may use the k-space intensity objective function.

The embodiments described herein provide a number of improvements and advantages over currently used methods for determining physical characteristics like depth and BCD for target structures like TSV and deep trenches. For example, the new physics augmented regression algorithm described herein can find the globally optimum solution for the depth parameter, thereby improving the depth fitting accuracy and precision, and leading to better BCD fitting accuracy and precision. In addition, compared to a global scan of the depth via multiple chi-square-based regressions, the physics augmented regression embodiments described herein are a much faster regression algorithm. Furthermore, the new physics augmented regression algorithm described herein can be applied to decorrelate various relatively low sensitivity parameters in simulated and measured spectra thereby further improving the ability to determine CD successfully, precisely, and accurately.

In addition to the embodiments already described, several alternatives are possible when implementing the new embodiments described herein. For example, the embodiments described herein can be applied to many other situations where signals have relatively low amplitude, relatively high frequency oscillations that contain important information to be isolated. In just a few, non-limiting such examples, the embodiments can be useful for VNAND targets and relatively thick multi-layer film targets. In another example, different regions of the k-space range can be chosen, either singly or multiple at a time, to capture different physical effects in the signal. Selecting different regions of the k-space range in this manner allows for the simultaneous isolation of multiple parameters, allowing for the same advantages gained above.

In a further example, different algorithms can be applied to automatically determine the k-space range of interest. For example, known signal noise can be converted to the k-space and that may be used as a baseline of choosing k-space regions that have a suitable signal-to-noise (SNR) ratio. In addition, envelope algorithms can be used to identify regions that compactly contain information. Furthermore, instead of restricting the range according to measured data, a range can be selected based upon the model's depth range, and a k-space range can be determined that would encompass all possible geometry within the model's limits.

Different physical phenomenon can also be characterized from a physics standpoint and exploited in the embodiments described herein. For example, the embodiments are described herein with respect to an application in which depth of a relatively high aspect hole is extracted. This depth determination is performed by isolating the physics that describe the impact of the depth on the measured signal. In structures with substantially tall and highly regular film stacks, like VNAND, resonant oscillations can be seen in the measured spectra that are dependent on the thicknesses of the constituent films. This information is also contained in a low amplitude, high frequency signal that is highly correlated with other model parameters. Characterizing the constructive and destructive interferences with the known physics of a film stack, a similar algorithm can be derived to isolate and successfully determine the films physical characteristics.

The detailed implementation of the objective functions can also be altered. For example, the k-space phase slope function calculates a single slope for the starting and ending points of a single range. This implementation can be replaced by the sum of multiple slope calculations in the range or estimation of the instantaneous derivatives at each sample in the range.

The advantages described above are provided by a number of important differences between the embodiments described herein and previously used metrology methods and systems. For example, by analyzing the physical relationship between a CD and the measured signal, the inventors have identified the nature in which the signal can be reanalyzed to achieve decorrelation of the CD from other parameters. Another important new feature is that by using the physics of the target, the algorithm automatically identifies and isolates the information after processing into the k-space. An additional new feature of the embodiments is that they enable information for multiple properties of the target to be simultaneously isolated and decorrelated. Furthermore, using FFT and k-space analysis, the embodiments are able to isolate and successfully regress on relatively low amplitude, relatively high frequency oscillations in a measurement that otherwise would be too insensitive to regress.

A further, important new feature of the embodiments described herein is that they can include a new seeding model (using equation 5) that was developed for substantially high aspect ratio structures like holes, filled or otherwise. Another important, new feature of the embodiments described herein is that they can be configured for a new multi-step regression algorithm created to progressively decorrelate and determine CD in relatively large pitch targets. An additional important, new feature of the embodiments is the three new k-space analysis techniques that have been developed. These techniques allow the embodiments to robustly extract information in the k-space despite noise, variations in the target, and fundamental differences between the theoretical model and the measurement.

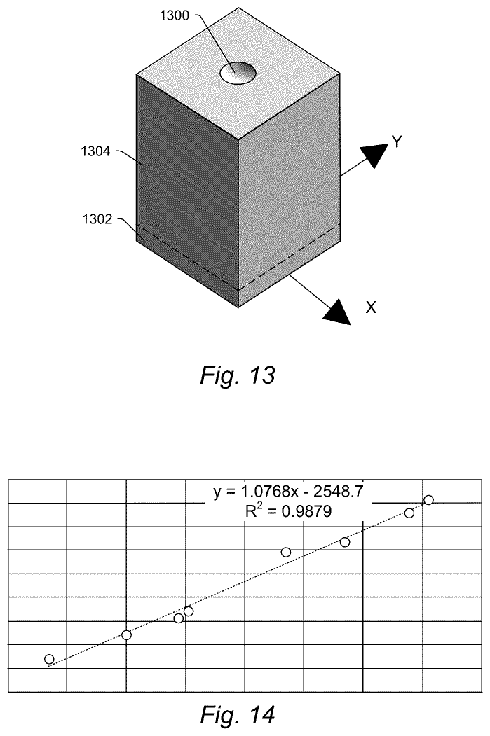

The following description of non-limiting examples of results produced with the embodiments described herein is intended only to further promote understanding of the embodiments. FIG. 13 illustrates a large pitch, deep (e.g., 55 um deep) TSV structure that may be formed on a TSV wafer. The 3D view of the TSV large pitch target in FIG. 13 shows TSV target 1300 formed in a couple of film layers, e.g., layers 1302 and 1304, formed on top of silicon (not shown in FIG. 13), each with its own material thickness.

The critical parameters of this target are the depth, TCD, and BCD, which may be defined relative to TSV target 1300 as shown in FIG. 4.

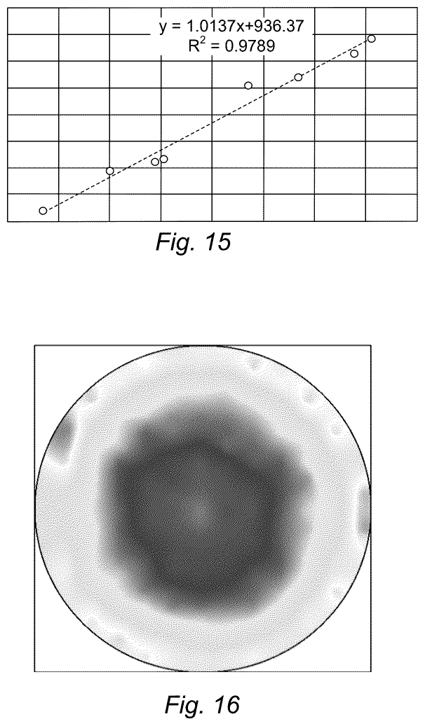

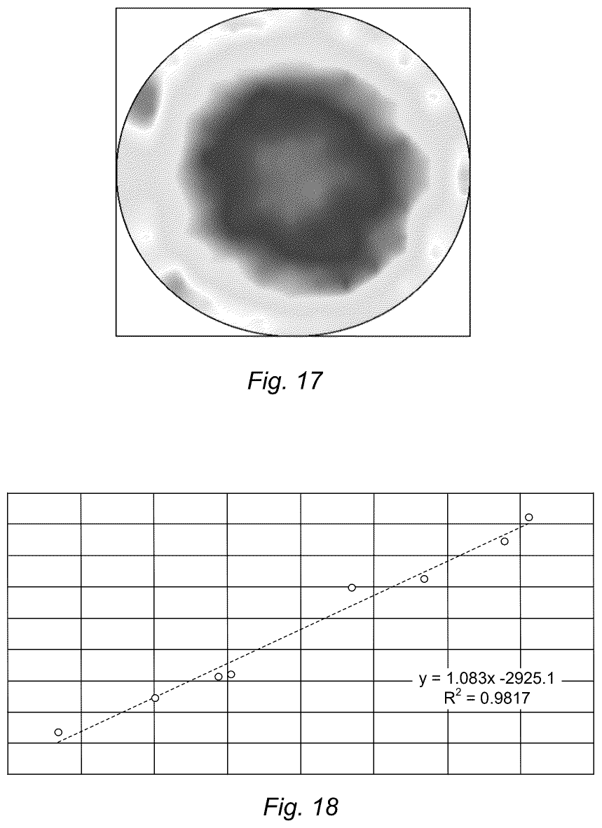

The TSV depth regression results for linearity are calculated against reference data using the multi-pass regression described herein. Using the k-space intensity as the objective function for depth, the resulting linearity is R²=0.9879 as shown in FIG. 14. Using the k-space unwrapped phase slope as the objective function for the depth, R²=0.9789, as shown in FIG. 15. FIGS. 16 and 17 show the depth fitting results using the k-space intensity for a process of record (POR) wafer and a POR+ wafer, respectively (where POR+ means that the target on this wafer has a deeper depth than the POR wafer). As shown in these figures, the within wafer depth trending is good. In other words, the full wafer map depth fitting results show a clear wafer pattern that generally agrees with user expectations. For example, based on the process, a user may think that the wafer center should have a deeper depth than the wafer edge and therefore the fitting results, if they are “good” should match that.

Table 1 shows the dynamic precision for the depth using the k-space intensity.

TABLE 1

| Site # (repeat measurement 10 times) | Precision Percentage |
|---|---|
| 1 | 0.054% |
| 2 | 0.048% |
| 3 | 0.042% |
| 4 | 0.028% |
| 5 | 0.057% |
| 6 | 0.039% |
| 7 | 0.036% |
| 8 | 0.039% |
| 9 | 0.033% |
| 10 | 0.041% |
| Average | 0.042% |

Table 2 shows the dynamic precision for the depth using the k-space phase slope method.

TABLE 2

| Site # (repeat measurement 10 times) | Precision Percentage |
|---|---|
| 1 | 0.1742% |
| 2 | 0.1386% |
| 3 | 0.1541% |
| 4 | 0.1071% |
| 5 | 0.2362% |
| 6 | 0.2348% |
| 7 | 0.1618% |
| 8 | 0.1750% |
| 9 | 0.1783% |
| 10 | 0.1289% |
| Average | 0.168899% |

Table 3 shows the dynamic precision when using a combination of the k-space intensity and the chi-square cost function (in steps 1206 and 1210 of FIG. 12, respectively), which gives the best precision, far beneath current requirements.

TABLE 3

| Site # (repeat measurement 10 times) | Precision Percentage |
|---|---|
| 1 | 0.002048% |
| 2 | 0.003522% |
| 3 | 0.000824% |
| 4 | 0.000595% |
| 5 | 0.000431% |
| 6 | 0.000715% |
| 7 | 0.000575% |
| 8 | 0.000395% |
| 9 | 0.000556% |
| 10 | 0.000131% |
| Average | 0.000979% |

The linearity using the k-space intensity and chi-square cost functions (in steps 1206 and 1210 of FIG. 12, respectively) is R²=0.9817, as shown in FIG. 18.

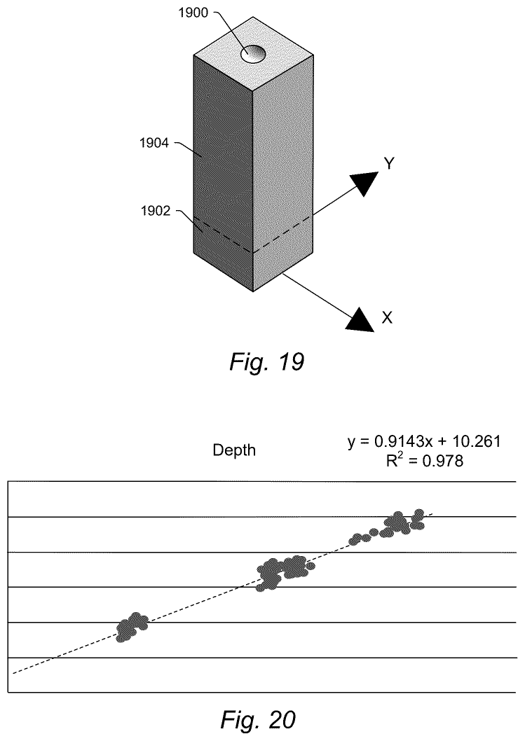

FIG. 19 shows another example of a large pitch, deep TSV that has a deeper depth (e.g., 100 um) than the TSV shown in FIG. 13. The 3D view of the TSV large pitch target in FIG. 19 shows TSV target 1900 formed in a couple of film layers, e.g., layers 1902 and 1904, formed on top of silicon (not shown in FIG. 19), each with its own material thickness. The critical parameters of this target are the depth, TCD, and BCD, which may be defined relative to TSV target 1900 as shown in FIG. 4.

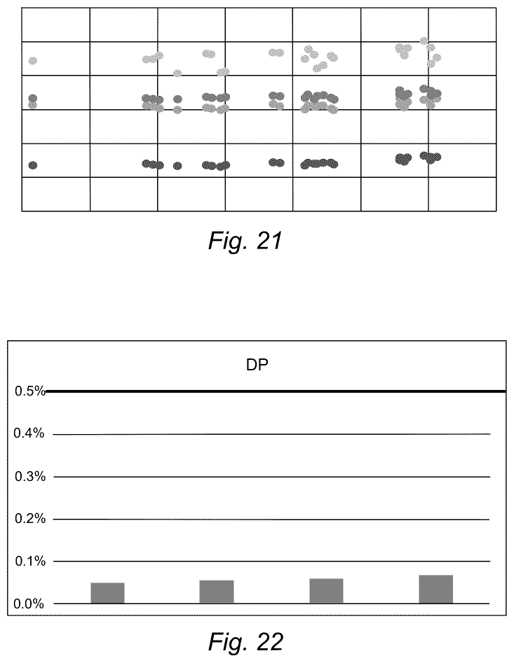

Using the k-space intensity objective function, the inventors got the following results. A linearity of R²=0.978 is observed for the depth, as shown in FIG. 20. The regressed depth CD shows excellent DOE wafer splits, as shown in FIG. 21. In addition, the resulting dynamic precision (DP) easily satisfies current requirements (i.e., a DP below 0.5%), as shown in FIG. 22.

The characteristics that are determined by the embodiments described herein can be used in the same manner as any other metrology measurements performed on specimens such as those described herein. For example, as described further below, the determined characteristics can be used to determine information for and/or monitor and control one or more fabrication processes performed on the specimen. In addition to such functions, the determined characteristics can be further processed to determine additional information about the specimen and/or the processes performed on it. Furthermore, although the embodiments are described herein with respect to a target structure on a specimen, the embodiments may be configured for determining physical characteristic(s) of any number of target structures on the specimen or multiple specimens.

The computer subsystem may also be configured for generating results that include the determined physical characteristic(s) of the target structure on the specimen, which may include any of the results or information described herein. The results of determining the physical characteristic(s) may be generated by the computer subsystem in any suitable manner. All of the embodiments described herein may be configured for storing results of one or more steps of the embodiments in a computer-readable storage medium. The results may include any of the results described herein and may be stored in any manner known in the art. The results may have any suitable form or format such as a standard file type. The storage medium may include any storage medium described herein or any other suitable storage medium known in the art.

After the results have been stored, the results can be accessed in the storage medium and used by any of the method or system embodiments described herein, formatted for display to a user, used by another software module, method, or system, etc. to perform one or more functions for the specimen or another specimen of the same type. In addition, the results may include any information for the specimen determined as described herein.

That information may be used by the computer subsystem or another system or method for performing additional functions for the specimen. Such functions include, but are not limited to, altering a process such as a fabrication process or step that was or will be performed on the specimen in a feedback or feedforward manner, etc. For example, the computer subsystem may be configured to determine one or more changes to a process that was performed on the specimen and/or a process that will be performed on the specimen based on the determined physical characteristic(s). The changes to the process may include any suitable changes to one or more parameters of the process. In one such example, the computer subsystem preferably determines those changes such that any determined physical characteristic(s) that are outside of an acceptable range of values are corrected on other specimens on which the revised process is performed, are corrected on the specimen in another process performed on the specimen, are compensated for in another process performed on the specimen, etc. The computer subsystem may determine such changes in any suitable manner known in the art.

Those changes can then be sent to a semiconductor fabrication system (not shown) or a storage medium (not shown) accessible to both the computer subsystem and the semiconductor fabrication system. The semiconductor fabrication system may or may not be part of the system embodiments described herein. For example, the metrology subsystem and/or the computer subsystem described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

Each of the embodiments of each of the systems described above may be combined together into one single embodiment.

Another embodiment relates to a computer-implemented method for determining information for a specimen. The method includes illuminating a target structure on a specimen with an energy source and detecting signals responsive thereto, which are performed with a metrology subsystem. The metrology subsystem may have any of the configurations described herein. The method also includes determining one or more of different physical characteristics of the target structure by inputting the detected signals into a physics augmented regression algorithm. The physics augmented regression algorithm includes a regression algorithm and an objective function. The objective function is configured for separation of relationships between the detected signals and the different physical characteristics of the target structure. The physics augmented regression algorithm may be further configured as described herein. The inputting is performed by a computer subsystem, which may be configured according to any of the embodiments described herein.

Each of the steps of the method may be performed as described further herein. The method may also include any other step(s) that can be performed by the metrology subsystem, computer subsystem, and/or system described herein. In addition, the method described above may be performed by any of the system embodiments described herein.

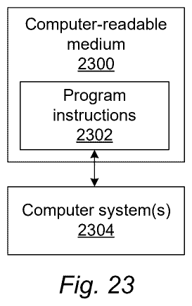

An additional embodiment relates to a non-transitory computer-readable medium storing program instructions executable on a computer system for performing a computer-implemented method for determining information for a specimen. One such embodiment is shown in FIG. 23. In particular, as shown in FIG. 23, non-transitory computer-readable medium 2300 includes program instructions 2302 executable on computer system 2304. The computer-implemented method may include any step(s) of any method(s) described herein.

Program instructions 2302 implementing methods such as those described herein may be stored on computer-readable medium 2300. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system 2304 may be configured according to any of the embodiments described herein.

Further modifications and alternative embodiments of various aspects of the invention will be apparent to those skilled in the art in view of this description. For example, methods and systems for determining information for a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system configured for determining information for a specimen, comprising:
a metrology subsystem configured for illuminating a target structure on a specimen with an energy source and detecting signals responsive thereto;
a computer subsystem; and
a physics augmented regression algorithm executed by the computer subsystem and comprising a regression algorithm and an objective function, wherein the objective function is configured for separation of relationships between the detected signals and different physical characteristics of the target structure:
wherein the computer subsystem is configured for inputting the detected signals into the physics augmented regression algorithm; and
wherein the physics augmented regression algorithm is configured for determining one or more of the different physical characteristics of the target structure from the inputted detected signals.

2. The system of claim 1, wherein the target structure comprises a large pitch target that causes high-frequency, small-amplitude oscillations in the detected signals.

3. The system of claim 1, wherein the target structure comprises a deep trench that causes high-frequency, small-amplitude oscillations in the detected signals.

4. The system of claim 1, wherein the target structure comprises a through-silicon via that causes high-frequency, small-amplitude oscillations in the detected signals.

5. The system of claim 1, wherein the regression algorithm comprises a gradient-based nonlinear regression algorithm.

6. The system of claim 1, wherein the objective function comprises a phase counting difference objective function determined as a discrepancy in phase counts between the detected signals and predicted signals generated for the target structure by the regression algorithm.

7. The system of claim 1, wherein the objective function comprises a k-space intensity difference objective function determined by transforming the detected signals and predicted signals generated for the target structure by the regression algorithm to k-space and determining an intensity difference between the detected signals and the predicted signals within one or more specified ranges of the k-space.

8. The system of claim 7, wherein the physics augmented regression algorithm is further configured for estimating an initial depth value for the target structure and determining the one or more specified ranges based on the initial depth value.

9. The system of claim 1, wherein the objective function comprises a k-space unwrapped phase slope difference objective function determined by transforming the detected signals and predicted signals generated for the target structure by the regression algorithm to k-space and determining a difference in unwrapped phase slope between the detected signals and the predicted signals over one or more specified ranges within the k-space.

10. The system of claim 9, wherein the physics augmented regression algorithm is further configured for estimating an initial depth value for the target structure and determining the one or more specified ranges based on the initial depth value.

11. The system of claim 1, wherein the determined one or more of the different physical characteristics comprise a bottom critical dimension of the target structure, and wherein the separation of the relationships between the detected signals and the different physical characteristics of the target structure for which the objective function is configured reduces error in the determined bottom critical dimension due to variations in a depth parameter for the target structure.

12. The system of claim 1, wherein the physics augmented regression algorithm is further configured for determining the one or more of the different physical characteristics in a multi-pass regression comprising multiple regression steps.

13. The system of claim 12, wherein a first of the multiple regression steps comprises floating only a top critical dimension of the target structure and determining the top critical dimension with the regression algorithm and a chi-square objective function.

14. The system of claim 13, wherein a second of the multiple regression steps comprises floating only thickness of one or more films in which the target structure is formed and determining the thickness with the regression algorithm and the chi-square objective function.

15. The system of claim 14, wherein a third of the multiple regression steps comprises floating only the top critical dimension and the thickness and determining the top critical dimension and the thickness with the regression algorithm and the chi-square objective function.

16. The system of claim 15, wherein a fourth of the multiple regression steps comprises floating only depth of the target structure and determining the depth with the regression algorithm and the objective function.

17. The system of claim 16, wherein a fifth of the multiple regression steps comprises floating only a bottom critical dimension of the target structure and determining the bottom critical dimension with the regression algorithm and the objective function.

18. The system of claim 16, wherein a fifth of the multiple regression steps comprises floating only a bottom critical dimension of the target structure and determining the bottom critical dimension with the regression algorithm and a different objective function configured for the separation of the relationships between the detected signals and the different physical characteristics of the target structure.

19. The system of claim 16, wherein a fifth of the multiple regression steps comprises floating only the depth and redetermining the depth with the regression algorithm, the chi-square objective function, and the depth determined in the fourth of the multiple regression steps as a regression starting value.

20. The system of claim 19, wherein a sixth of the multiple regression steps comprises floating only a bottom critical dimension of the target structure and determining the bottom critical dimension with the regression algorithm and the objective function.

21. The system of claim 19, wherein a sixth of the multiple regression steps comprises floating only a bottom critical dimension of the target structure and determining the bottom critical dimension with the regression algorithm and a different objective function configured for the separation of the relationships between the detected signals and the different physical characteristics of the target structure.

22. A non-transitory computer-readable medium, storing program instructions executable on a computer system for performing a computer-implemented method for determining information for a specimen, wherein the computer-implemented method comprises:
illuminating a target structure on a specimen with an energy source and detecting signals responsive thereto, wherein said illuminating and detecting are performed with a metrology subsystem; and
determining one or more of different physical characteristics of the target structure by inputting the detected signals into a physics augmented regression algorithm, wherein the physics augmented regression algorithm comprises a regression algorithm and an objective function, wherein the objective function is configured for separation of relationships between the detected signals and the different physical characteristics of the target structure, and wherein said inputting is performed by a computer subsystem.

23. A computer-implemented method for determining information for a specimen, comprising:
illuminating a target structure on a specimen with an energy source and detecting signals responsive thereto, wherein said illuminating and detecting are performed with a metrology subsystem; and
determining one or more of different physical characteristics of the target structure by inputting the detected signals into a physics augmented regression algorithm, wherein the physics augmented regression algorithm comprises a regression algorithm and an objective function, wherein the objective function is configured for separation of relationships between the detected signals and the different physical characteristics of the target structure, and wherein said inputting is performed by a computer subsystem.
